(19) United States
(12) Patent Application Publication
(10) Pub. No.: US 2024/0176786 A1
(43) Pub. Date: May 30, 2024

(54) CONTEXT-BASED SEARCH OF DOCUMENT MANAGEMENT SYSTEM

(71) Applicant: Honeywell International Inc., Charlotte, NC (US)

(72) Inventors: Ankit SINGH, Apex, NC (US); Jason HALPERN, Elkins Park, PA (US); Lakshminarayana PAILA, Knoxville, TN (US)

(21) Appl. No.: 18/060,427

(22) Filed: Nov. 30, 2022

(51) Int. Cl. G06F 16/2457

(52) U.S. Cl. CPC G06F 16/24575; G06F 16/24578

(57) ABSTRACT

A method of generating refined search results includes: receiving, from a user, a unique identity associated with the user; generating a unique user search profile based on the unique identity associated with the user; receiving, from the user, a first search query including at least one key term; applying the unique user search profile to the first search query to query one or more databases from a selected plurality of databases to generate a unique user first search query; generating a unique first search result comprising a plurality of first search result documents ranked based on the unique identity associated with the user; and providing the unique first search result to the user.

### TECHNICAL FIELD

The present disclosure relates generally to systems and methods for context based searching, and, more specifically, to systems and methods for context based searching within a document management system.

### BACKGROUND

Document management systems may contain or otherwise have access to databases storing large sets of data including the documents generated by an organization. Performing a text-based search of such large sets of data may generate results of some value, but the lack of context in the general, text-based search may prevent a searcher from reaping complete value and obtaining search results that are most germane to his or her query. For example, if a searcher who needs one or more documents related to one or more business practices or procedure (e.g., a financial audit, factory processes, manufacturing facility procedures, etc.) searches merely for the a term related to their query, the searcher may be presented results from portions of the business that are not related to the aspects of the present search. For example, results from another sector of the corporation, from an irrelevant time frame, or based on some other irrelevancy.

Because the time of users in an organization is its most valuable assets, and because searches that do not provide contextualized results, such results may lead to inaccurate search results, incorrect actions, and a decrease in productivity. The systems and methods described herein attempt to solve one or more of the problems described above. However, the background description provided herein is for the purpose of generally presenting the context of the disclosure and the scope of the present application is delineated by the claims appended hereto. Unless otherwise indicated herein, the materials described in this section are not prior art to the claims in this application and are not admitted to be prior art, or suggestions of the prior art, by inclusion in this section.

### SUMMARY

In one embodiment, a method of generating refined search results includes: receiving, from a user, a unique identity associated with the user; generating a unique user search profile based on the unique identity associated with the user; receiving, from the user, a first search query including at least one key term; applying the unique user search profile to the first search query to query one or more databases from a selected plurality of databases to generate a unique user first search query; generating a unique first search result comprising a plurality of first search result documents ranked based on the unique identity associated with the user; and providing the unique first search result to the user.

In another embodiment, a method of providing refined search results to a user based on a unique profile of the user, the method includes: determining a unique user identity of the user; accessing at least one database including metadata associated with the unique user identity; generating a user search modifier that modifies a search of the user based on one or more user search modifier factors; presenting the modified search request including at least one key term to at least one database including a plurality of documents; receiving a search response based on the presented search request, wherein the one or more user search modifier factors include one or more of: a department of the user, a user history of the user; a user history of all users in the user's department.

In yet another embodiment, identifying a user based on a user profile; receiving a search query from the user; modifying the user's search query based on the user profile; presenting the modified search query to a documents storage; receiving a search response from the documents storage; and presenting the search response to the user, wherein the search response includes one or more ranked search results based on the modified search query.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

Embodiments of the disclosure will now be described, by way of example only, with reference to the accompanying drawings in which:

FIG. 1 illustrates an exemplary computer environment for searching for and accessing one or more documents based on a context-based user query, according to one or more embodiments shown and described herein.

FIG. 2 illustrates an exemplary factory/manufacturing environment for implementing one or more of the systems and methods for context-based user query described herein.

FIG. 3 illustrates an exemplary system diagram for generating context-based search results.

FIG. 4 illustrates an exemplary system environment for performing a context-based search.

FIG. 5 illustrates a method for conducting a context-based search.

FIG. 6 illustrates a second method for conducting a context-based search.

### DETAILED DESCRIPTION

As mentioned briefly above, document management systems (DMS) can provide access to databases storing large sets of data including the documents generated by an organization. Performing a text-based search of such large sets of data may generate results of some value, but the lack of context in the general, text-based search may prevent a searcher from reaping complete value and obtaining search results that are most germane to his or her query. For example, if a searcher who needs one or more documents related to a financial audit searches merely for the term “financial audit,” the searcher may be presented results from portions of the business that are not related to the aspects of the present search. For example, results from another sector of the corporation, from an irrelevant time frame, or based on some other irrelevancy.

However, each individual user that performs a search can be identified using their login credentials or another aspect of their logon profile. Such particular aspects can be identified for a context engine and when such searcher performs a search, this identity-based context could further contextualize search results for the user. Additionally, current business circumstances could be used to contextualize a search, especially in light of the user's profile. For example, if three recent quality assurance reports were generated in a particular division of a business, the searches by a user in that division could be contextually focused on documents related to quality assurance reports. The systems and methods described herein relate to providing users with context-based reports in order to increase the efficacy of search queries for users.

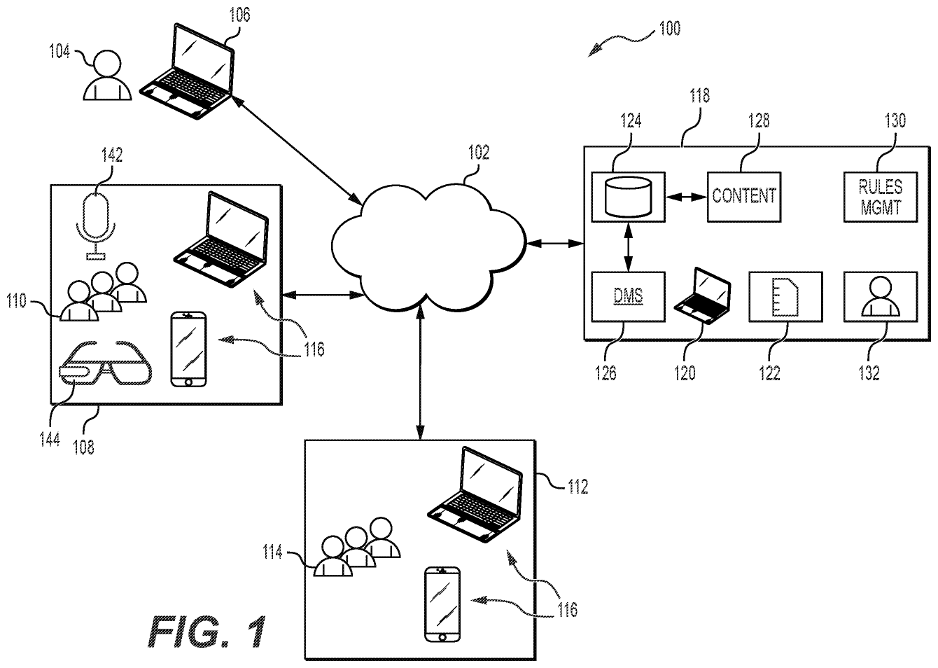

Referring to FIG. 1, a system 100 for providing context-based full text search results is shown. The system 100 may include a plurality of nodes comprising one or more processing devices (e.g., personal computers, computer networks, personal devices, device networks, etc.) communicatively coupled to a network 102. One or more users may be connected to the network 102. For example, an admin 104 may connect to the network through an admin device 106. In embodiments, users may be grouped via department. For example, a first department 108 may include one or more users 110 and a second department 112 may include one or more users 114. The users may connect to the network 102 via user devices 116. A document management system 118 may be communicatively coupled to the network 102. The document management server 118 may comprise one or more processing devices 120, one or more memory devices 122, one or more databases 124, a document management system (DMS) module 126, a content module 128, a rules management module 130, and a user profile module 132. In some embodiments, one or more of the users 110 may provide inputs to the system 100 via one or more input devices. For example, the users 110 may provide input to the system 100 via an audible input 142 and/or a hands-free input 144. The audible input 142 may be communicatively coupled to, for example, software for understanding one or more speech inputs and the hands-free input 144 may be capable of receiving and providing to the system 100 one or more inputs based on visual and/or audible data (e.g., by scanning a QR code, etc.)

The network 102 may be used to transmit data from the various data processing devices to the server (e.g., a computer of any appropriate configuration) in an appropriate manner. For instance, the data processing device(s) and the server may communicate over a local area computer network (LAN) or a public computer network (e.g., the Internet). In some embodiments, the network 102 may be a private LAN and may be separated from the public Internet by, for example, a firewall. The information associated with a context-based search may be transmitted from the server to one or more of the nodes in any appropriate manner. For instance, the server and a node (e.g., a personal computer; a desktop computer; a laptop computer; a “dumb” terminal) at any location connected to the network may communicate over a computer network, such as a public computer network (e.g., the Internet). A web application may be used to view search results as well.

The one or more processors 120 may communicatively couple with the one or more memory devices to perform one or more of the computer-based methods described herein. The DMS 118 may enable users to manage one or more types of files such as, for example, text-based files, charts, presentations, images, videos, sounds, and other types of files. The DMS 118 may present one or more interfaces including a query function, allowing users to search a connected database and may provide search results using a search engine that can conduct a search of the relevant databases communicatively coupled to a device of the user. In some embodiments, the relevant databases may be automatically selected for a given search based on a profile of the user (as determined, for example, with the user profile module 132). The automatically selected databases may be a default setting based on, for example, a profile of the user (e.g., to which department a user identity is assigned) and the selected databases may be configurable such that a user can decide which databases the user's queries search.

The content module 128 may include one or more caches or containers for storing corporate documents and other content. In embodiments, a content type may define how the content is stored in the content module 128. For example, business logic and methods, database structure, definitions (e.g., schema, field, table, etc.) and associated content of different content types may be stored in different manners, accordingly. Business logic and the methods of the module may be configured to act based on particular content items having been stored in the database (e.g., in the case of a particular search query). For example, content with a characterization of “corporate” or characterized as belonging to a particular department (e.g., Quality Review, Testing, Sales, Corporate, etc.) may relate to users from the respective department and may be configured to populate search results at a higher rate based on searches from users in that respective department. The content type may include documents which are only visible to users of one or more particular department (e.g., only visible to members of the Sales department or only visible to members of the Corporate department, etc.) and such content may never be visible in searches from members of departments which do not have access to such labeled content. Content type may be based on a user's role within a department and content may be filtered and/or stored based on such role. For example, content generated (e.g., reports generated) by a Researcher may be labeled as such and may be more likely to populate in searches by other Researchers even if the researcher is from a separate department. Similarly, content labeled as generated by a user with a Sales function may be more likely to populate in searches by other users with a Sales function.

The rules management module 130 may administrate one or more search query result ranking rules (“ranking rules”) for ranking search results in order to present the most relevant results to a user. In some embodiments, ranking rules may be used to promote or demote a particular search result in a listing of search results, such that the promoted or demoted search result may increase or decrease in ranking, respectively. This may reposition the particular item in the results listing to make it more likely that a user is aware of the particular search result. An example ranking rule may include, for example:

Query Result=0.2 (Department weight)+0.3 (User history weight)+0.25 (Quality event weight)+0.25 (Preconfigured tags weight)

As such, in the present example, a search result item (i.e., a document) that has been tagged with or that has been searched by previous users such that it has resulted with a tagged user history similar to the user history of the particular searching user will be more likely to populate toward the top of a results list than a document that has a similar quality event weight as to that of the searching user. In some embodiments, after a query based on a user's input has been effected, items returned based on the query (e.g., that relate to one or more elements of the query and/or satisfy at least a portion of the search query), the item(s) returned by the search query may be listed in a ranked search results page (e.g., a web page). The ranked search results may be based on a score calculated to the individual listing items. In embodiments, the items receiving the highest score may be listed near the top of the search results, such that they are more likely to be reviewed by a user.

The user profile module 132 may collect or receive user profile information from the various users of the systems. In some embodiments, the user profile information includes information about the user such as the user's department, the user's role within the department or larger organization as a whole, a current or typical location of the user, various certifications or accreditations of a user, or other information. User profile information may include information related to documents opened, documents read (e.g., by determining a length that a particular document is open and active on a user's screen, etc.), documents interacted with, documents drafted and information about the documents drafted (e.g., length, word choice, etc.), recent searches by the user, and other information. In some embodiments, the user may update information associated with his or her profile individually. For example, a user may input his or her department when creating his or her own user profile (e.g., by selecting a department from amongst various departments in a drop down) or may assign one or more filters temporarily to his or her profile. For example, if a user knows that they do not wish to receive search results including documents from before a particular date (e.g., May 1, 2020), the user could add such restriction to their profile. User profile information may be collected and stored in a database, for example, the database(s) 124. Additionally, the user profile module 132 may assign a correlation between a particular search result in a set of search results as of particular interest to a given user profile with a correlation number, which correlation number may be used to update future search results. The user profile correlation number may quantify a correlation between multiple search results and various individual search results.

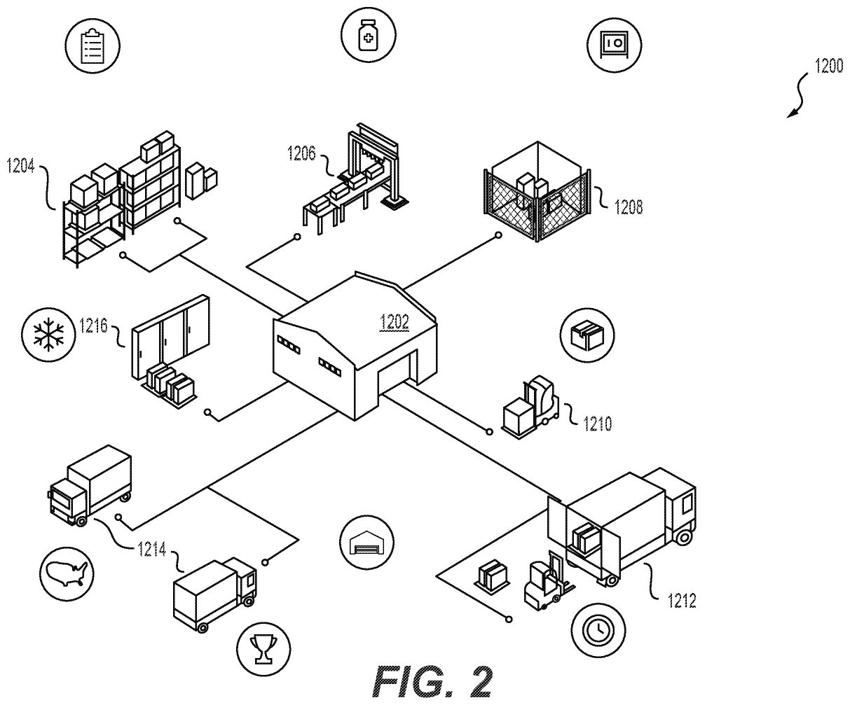

Referring to FIG. 2, an exemplary manufacturing operation 1200 is shown. The manufacturing operation may include an exemplary factory/warehouse 1202, which may be configured to operate, at least in part, based on one or more automated or semi-automated procedures carried out by a warehouse management system (WMS) 1204. The factory/warehouse 1202 may be an automated or semi-automated environment and may include one or more automation technologies such as carousels, a-frames, and sorting systems. The WMS 1204 may generally track inventory levels and optimize workflow and storage. The manufacturing operation 1200 may be configured such that products are shipped to one or more distributors 1206. Further, in some embodiments, the products created, stored, and shipped with the logistical operation 1200 may be controlled substances and may require storage in one or more high-security areas 1208. The high-security areas may have access controls and systems generating data regarding the controlled substances may be generated, stored, and transmitted subject to one or more sensitivity levels or access controls. The manufacturing operation 1200 may include one or more automated, semi-automated, or manually operated pickers 1210 and products may be shipped, for example, using one or more trucks 1212. In some embodiments, the trucks 1212 may part of a distribution network 1214, which may distribute one or more products (e.g., therapeutic drugs, vaccines, etc.) In some embodiments, the products must be stored in refrigerated storage 1216 to meet one or more product requirements. Products stored in refrigerated storage 1216 may require insulated and/or refrigerated transportation and may be monitored during storage for temperature and other criteria. The various portions and steps of the manufacturing operation 1200 can be automatically and/or manually tracked, for example using one or more sensors or input from personnel associated with the logistical operation (who could be users of the network 102, for example). The data generated in carrying out the day-to-day operations of the manufacturing operation 1200 is exemplary data which could be used in the systems and methods context based results filtering as described herein. The data generated (e.g., number of units (e.g., pills, vials, etc.) created, number of units shipped, number of units destroyed, etc.) will include metadata associated with the data itself which can be used to provide relevant context about all facets of the manufacturing operation 1200.

Within the manufacturing operation 1200, various aspects of the system 100 can be used to increase context for filtering a searcher's results. For example, a user's location (as determined, for example, based on an RFID tag within a badge of the user and a reader at various locations in the manufacturing operation 1200) within the manufacturing operation 1200 could be used to increase context for search results. For example, if a user spends time near a refrigerated storage 1216, search results may be filtered automatically based on relevance of the documents to items relating to the cold storage. As another example, if refrigerated storage equipment was scheduled to reach an expiration soon (e.g., a calibration for a freezer's thermostat) and a user receives an email regarding the expiration, the fact that the user received the email and whether or not the user opened and/or read the email could be used as context for the user's search results.

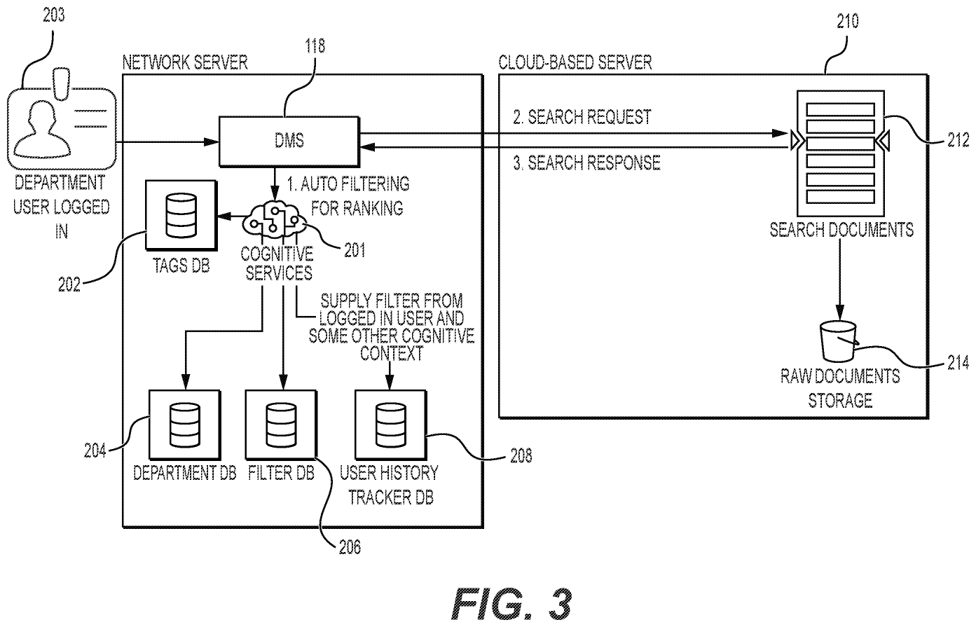

FIG. 3 shows the document management system (DMS) 118 in greater detail. The DMS 118 may include or otherwise be communicatively coupled to a cognitive services engine 201, a tags database 202, a user identifier 203 (such as a badge or other identifying feature), a department database 204, a filter database 206, and a user history tracker database 208. In some embodiments, the DMS 118 is communicatively coupled to a cloud-based server 210 which may include a search documents application 212 that is communicatively coupled to a raw documents storage 214.

The DMS 118 may be a system used to receive, track, manage and store documents. Additionally, the DMS 118 may manage updates, track revisions histories, provide an audit trail, and serve other document editing and tracking functions. Through its various modules and components, the DMS 118 may keep a record of various versions of documents created and modified by different users and may provide a history tracking function. The DMS 118 may store metadata for each document on the server. The metadata may include, for example, a date the document was stored and an identity of a user storing it, accessing it, and/or editing it. The DMS 118, through its various components and modules, may generate metadata about and/or extract metadata from the document automatically or prompt a user to add metadata. The DMS 118 may have, for example, one or more connected systems to utilize features such as, for example, optical character recognition on scanned images scanned using a scanner or camera, or to perform text extraction on electronic documents. Extracted text can be used, for example, to identify keywords, provide full text search, or to automatically fill or generate additional documents based on the extracted text. The DMS 118 may include one or more applications with word processing functions and extracted text may be used in such word processing functions to generate new documents or edit existing documents and extracted text can be stored as a component of metadata, stored with a document, or separately.

The DMS 118 may provide document management functionality to other connected applications allowing users to retrieve existing documents from the document management repository (e.g., the raw documents storage 214), make any necessary changes (e.g., in a word processing application), and save the changed document back to the repository (e.g., the raw documents storage 214) as a new version, an updated version, etc. The DMS 118 may be a component of, for instance, a workflow management system and/or a content management systems, which may be accessible via one or more additional APIs. The DMS 118 and its components and related functions may be based on open standards such as ODMA, LDAP, WebDAV, and SOAP or RESTful web services or closed standards.

In some embodiments, the DMS 118 may include one or more data validation functions, which may be based on, for example, one or more data validation rules which may check for missing pieces or other missing or inappropriate data in a document. For example, data validation functions may check for missing signatures, misspelled titles (e.g., titles of products, departments, and other entities) and names, and other issues and document failures, recommending real-time correction options before importing data into the DMS. Additional processing in the form of harmonization and data format changes may also be applied as part of data validation.

Additionally, the DMS 118 may include one or more indexing functions, which functions may track and store the electronic documents according to one or more criteria (e.g., a user/editor/contributor to a document, etc.) The indexing function may classify the document according to, for example, serial numbers assigned to the document and other information, for example, metadata attached to the document. The indexing function may support a query and/or retrieval function and the indexing function may provide or the rapid retrieval of documents based on the indexing topology as described in greater detail herein.

The cognitive services engine 201 may embody one or more artificial intelligence or machine learning algorithms which may be configured to, for example, derive an appropriate contextual framework for a user-provided search and based on the contextual framework, pre-filter search results to the user without any filtering conducted by the user him or herself. The functions of the cognitive services engine 201 can be context-based, so for example, the pre-filters may automatically be applied based on user settings or other settings. For example, if a user from a particular department conducts a search, that user's department may have predefined search filter criteria or all searches conducted by users from that department. The predefined search filter criteria can be selected by a department, for example, and set by an admin in the system to create the pre-filter function. In some embodiments, a user may be able to customize his or her pre-filter criteria from the default settings for a given department, changing individual settings or global settings to customize their own search profile. In some embodiments, the search filtering for a particular user can be based on current events and/or recent documents added to the DMS 118. For example, if a number of quality reviews (e.g., complaints) for a particular product have been received (e.g., as documents) and uploaded to the DMS 118 within the last several days and the user performs a search of the DMS 118 for documents related to that product (for example, by searching the product's name in the DMS 118), the filters may automatically apply a temporal or relevance filter to one or more documents related to that product. For example, it may return results which treat the concerned product as a main topic of the document (e.g., as determined by a word count compare of the product vs. other products, etc.)

The tags database 202 may store and/or manage metadata associated with corporate documents. The corporate documents may be generated by one or more users of the system and may include any type of document, for example, reports, charts, books, annual product quality reviews and portions thereof, etc. The tags database 202 may provide metadata of a document upon receipt of a search request from a user and the metadata provided may be used to rank search results and provide a context-based search result to the user based on the metadata. The tags database 202 may store metadata such as, for example, a description, a location, a “created by” tag, a creation date, a document owner, a document due date, tags relating to one or more linked records, a document length, word and/or character counts, a number of times a document is accessed, a user profile associated with accessing a document, a number of times a document is accessed by a particular profile, a number of times a document is accessed by users from a particular department, and other types of metadata. In some embodiments, the meta tags associated with a document may relate to the type of document to which the tag is attached. For example, a document may be saved with a “complaints related” tag, a “change controls related” tag, a “corrective action/preventive action (CAPA)” tag, or some other quality event tag. Tags related to the type of document that is tagged therewith may be assigned, for example, by a document administrator and/or a creator or user of the document.

The user badge 203 may include one or more features for identifying a location of the user, which location may be used to provide additional context to the searches of the user. For example, if a user logs on to a database from near a particular piece of equipment, documents regarding the piece of equipment may be more likely to populate the user's search results. The user badge 203 may include, for example, an RFID tag or other feature which may passively locate a user while he or she is at work location (e.g., within the manufacturing operation 1200, etc.)

The department database 204 may store and/or manage information related to a particular department, for example, the users of the department, the size of the department, access permissions of the users of the department, and other information related to the department. The department database 204 may specifically provide information regarding to which a particular logged in user may belong such that upon searching, the logged in user may be provided search results most germane to the logged in user as described herein. In some embodiments, user identities associated with users may be stored in the department database 204 to include a user's first and last names, an employee identification number, and other identification information associated with the employee/user.

The filter database 206 may include one or more filters that may allow a user to control which search results are presented for review and potential selection by a user by including or excluding particular results based on criteria or attributes of the results. The filter database can include and apply filters based on different sets of circumstances depending on the identity of a user or other aspects associated with the user. For example, the filter database may include separate sets of filters for users from different departments, for users from different geographic locations, for users logged in from different physical sites of the business, etc. In some embodiments, the filters database 206 may include a module or portions of a database for differentiating between profiles, for example, a “Profile A,” and a “Profile B.” Profile A might be assigned to someone who works, for example, on a manufacturing floor (e.g., within the manufacturing operation 1200) and within proximity to tools. Searches by the user associated with Profile A might consider the person's location, recent location(s), proximity, and notifications being emitted by machines within a particular proximity of a location associated with Profile A (e.g., by tracking a location of the user badge of the user associated with Profile A). Profile B might be associated with a user who works remotely, and hence the user badge or other locating device may not register with any hardware in the system. Accordingly, proximity might not be a search factor for the user associated with Profile B, but instead the system may focus more on the previous search history, previous actions related to documents, and other factors.

The user history tracker database 208 may store and/or manage information on, or related to, each user who uses the DMS 118. There may be, for example, two types of users with access to the system: admin users (e.g., the admin 104), who may access backend functions and manage the operational capabilities of the DMS 118, and ordinary users of the system, who may use the DMS 118 to store and retrieve corporate documents. The ordinary users of the DMS 118 may be, for example, employees of a firm or other organization with access to the DMS 118 in order to search for and retrieve corporate documents. The user history tracker database 208 may store and manage information regarding the employees and other ordinary users. In some embodiments, the user history tracker database 208 may track, monitor, and store the previous search responses and behaviors of a logged in as user history tracker data. The user history tracker data may be used in subsequent search requests to customize search results for the user. Such process may be iterative, such that the system 100 continuously learns any given user's search patterns and required data to provide ever more germane results. For example, if a user logs in to access the raw documents storage via the search documents function, the user history tracker database 208 may recall from which department the user logs in and may assign rules to the users search and/or search results based on the tracked user history. In some embodiments, the user history tracker database 206 may track the search requests and results for an entire department and may base search results on the most useful search results as presented to an entire department. In embodiments, the user history tracker database 208 may record a user document history which may be a history of the types of documents accessed and edited by a user, the amount of access and editing a user has made to a particular document by document type, length, department, etc. and other data related to the interaction of a user with a particular document.

The cloud-based server 210 may be communicatively coupled with the DMS 118 and may include the search documents application 212 and a raw documents storage 214. The search documents application 212 may perform a search of all corporate documents within a raw documents storage 214, which may be one or a plurality of databases storing documents of any file type, for a particular piece of text based on a received search request. The search documents application 212 may provide a search response may be provided based on the weights, rules, and other factors as described herein. The weights, rules, and other factors may be configured for a particular user or department of users. In some embodiments, documents may be saved, after they are created and/or edited by a user, with preconfigured tags based on one or more user identities and the preconfigured tags may be used to rank the documents in subsequent searches. For example, if a user from a sales department creates and/or edits a document and subsequently saves the created/edited document, the document may be tagged with a metadata tag related to the fact that it was accessed and edited by a member of the sales department such that the document may be ranked higher in subsequent searches by other members of the sales department. Conversely, if a member of a department other than sales, which member was not interested in seeing sales-related documents performed a search, the document would be ranked lower in searches returned by the non-sales member.

The raw documents storage 214 may store the electronic documents and other files (e.g., image files, video files, slide decks, etc.) Rules may effect where those documents are stored in the raw documents storage, for how long, migration of the documents from one location or media to another, and the destruction of documents within the raw documents storage 214. In some embodiments, retrieval of documents from the raw documents storage 214 may be capable by receiving a document identification, such as, for example, a unique document number, a metadata tag associated with the document, one or more keywords,

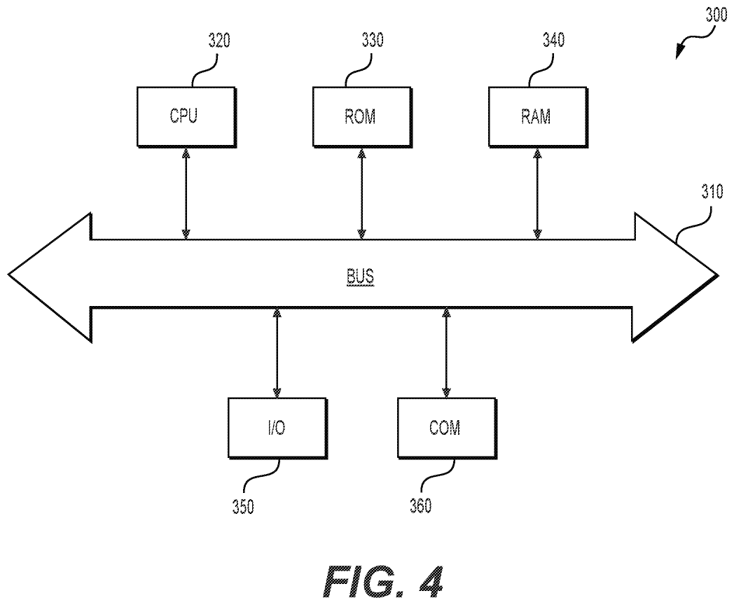

FIG. 4 is a simplified functional block diagram of a computing system 300 that may be configured for carrying out one or more of the steps, programs, and/or executing techniques described herein, according to exemplary embodiments of the present disclosure. Specifically, in one embodiment, any of the modules of the system 100 may be an assembly of software and/or hardware including, for example, a data communication interface 360 for packet data communication. The platform may also include a central processing unit (“CPU”) 320, in the form of one or more processors, for executing program instructions. The platform may include an internal communication bus 310, program storage, and data storage for various data files to be processed and/or communicated by the platform such as ROM 330 and RAM 340, although the system 300 may receive programming and data via network communications. The system 300 also may include input and output ports 350 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

Any suitable system infrastructure may be put into place to allow for the assessment of models monitoring devices. FIG. 4 and the following discussion provide a brief, general description of one example of a suitable computing environment in which certain embodiments and aspects thereof the present disclosure may be implemented. In one embodiment, any of the disclosed systems, methods, and/or graphical user interfaces may be executed by or implemented by a computing system consistent with or similar to that depicted in FIG. 4. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

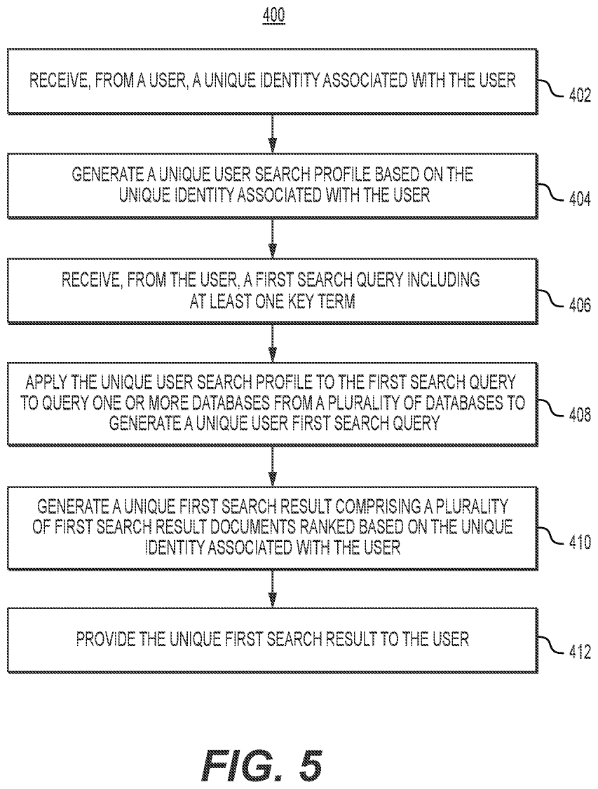

Referring to FIG. 5, a method 400 for providing unique search results to a user is shown. It is to be understood that the method for providing search results to a user shown in FIG. 5 is exemplary only and the ordinary artisan in the relevant art will recognize that additional, fewer, or alternate steps may be followed by a user and that any ensuing method would still be in keeping with the scope of the claims below.

At step 402, a unique identity associated with a user may be received by the DMS 118. The unique identity may be associated with one or more of the users of the system via, for example, a profile module or other access and identity management server, device, or application. In some embodiments, the unique identity may be identified in the user history tracker database and the user history tracker may begin tracking the actions of the user and associating them with searches and actions stored in the user history tracker database to maintain a history of user actions. The unique identity may include such information as a user's name, a number of times logged into the DMS, a history of documents access in the DMS, a history of the amount of time spent accessing documents in the DMS, a history of the number of pages and which pages are accessed by the user, and other information for generating contextual searches.

At step 404, a unique user search profile based on the unique identity associated with the user may be generated. The unique user search profile may be based on information described above, for example, a number of times logged into the DMS, a history of documents access in the DMS, a history of the amount of time spent accessing documents in the DMS, a history of the number of pages and which pages are accessed by the user, and other information for generating contextual searches. The unique user search profile is used to provide a basis for returning search results that are most useful to the user.

At step 406, a first search query including at least one key term may be received from the user. The query may be put into the system in a text based format, for example. The text can be any string of words, letters, and/or symbols indicating the data for which the user wants to search the documents storage. The query may be possible using one or more search languages/logics such as a Boolean search logic. The first search query is used as a baseline for subsequent searches and the query, as well as subsequent queries, may be stored and used to provide contextualized results in the future. For example, the future results may be refined based on whether or not the user actually selects one or more of the provided results.

At step 408, a unique user search profile may be applied to the first search query to query one or more databases from a plurality of databases to generate a unique user first search query. That is, no two users may receive equivalent search results based their searches as modified by their identified and saved unique user search profiles. In some embodiments, the user profile may weight factors associated with the user profile differently for each user and the weights for any given factor may change as a user continues to use the search functions (i.e., the weights applied to the various factors are dynamic. As an example, a user logged in from a sales department may have a unique user search profile that is biases towards providing the user documents generated by the sales department. However, fi the sales department user routinely interacts with an auditing department and has a function within the sales department that has overlap with the auditing department, the particular sales department user may be provided a larger number of auditing department documents if the user selects multiple audit department documents, the sales department user may be shown more and more audit department documents as the sales department user clicks on and interacts with audit department-generated documents.

In some embodiments, the databases which are searched using the query may be based on the user profile. For example, the user profile may be associated with one or more databases where users having similar profile aspects are more likely to store and retrieve documents and such databases may return more useful results to searches from the user. For example, users from a sales department may be more likely to store documents within a sales database than another accounting database. Accordingly, searches of a plurality of databases which searches include both the sales database and the accounting database may be more likely to rank or score documents from the sales database higher than documents from the accounting database and thus would present a greater number of documents from the sales database to users from the sales department all other things being equal. This is of course merely one example.

Continuing with method 400, at step 410, a unique first search result, comprising a plurality of first search result documents ranked based on the unique identity associated with the user may be generated. The unique first search result may be unique to the user based on his or her user profile and search history as described herein. In some embodiments, the unique first search results may include documents, charts, images, sound, and other documents that may be relevant to the user based on his or her query. In some embodiments, the search results may be filterable by the user such that he or she can filter out results. In some embodiments, the filters applied by the user may be saved as part of the user's profile (e.g., in the user history tracker database) and may be recalled for later searches increasing the efficiency with which a user can search.

At step 412 the unique first search result may be provided to the user. The search result can be provided to a user at his or her device 116, where the results can be analyzed and the documents associated with each result can be selected and opened. In some embodiments, the documents may be saved by the user to his or her device based on the results of the search. In some embodiments, a preview of one or more of the search results may be available to a user of the system such that he or she can quickly obtain the nature of the relevance of the particular result and determine whether or not to access the particular result.

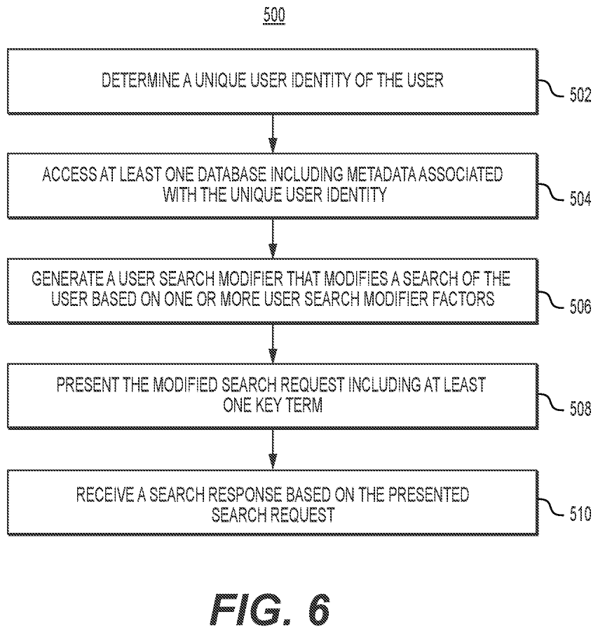

Referring to FIG. 6, a method 500 for providing search results to a user based on an identity of the user is shown. It is to be understood that the method for providing search results to a user shown in FIG. 6 is exemplary only and the ordinary artisan in the relevant art will recognize that additional, fewer, or alternate steps may be followed by a user and that any ensuing method would still be in keeping with the scope of the claims below.

At step 502, a unique user identity of a user may be determined. The unique identity may be associated with one or more of the users of the system via, for example, a profile module or other access and identity management server, device, or application. The unique user identity may be stored, for example, in the user profile module 132, which module may collect or receive user profile information from the various users of the systems. In some embodiments, user profile information can include access and identity information about the user such as the user's department, the user's role within that department, and to which documents a user may have access. User profile information may include information related to documents opened, documents read (e.g., by determining a length that a particular document is open and active on a user's screen, etc.), documents interacted with, documents drafted and information about the documents drafted (e.g., length, word choice, etc.), recent searches by the user, and other information. In some embodiments, documents or portions thereof may be stored according to a hierarchy of user access (e.g., on a scale of 1 to 10, for instance) and only users with an access at the required level on the scale can access such documents or portions thereof. In some embodiments, the unique identity may be identified in the user history tracker database and the user history tracker may begin tracking the actions of the user and associating them with searches and actions stored in the user history tracker database to maintain a history of user actions. The unique identity may include such information as a user's name, a number of times logged into the DMS, a history of documents access in the DMS, a history of the amount of time spent accessing documents in the DMS, a history of the number of pages and which pages are accessed by the user, and other information for generating contextual searches.

At step 504, at least one database including metadata associated with the unique user identity may be accessed. For example, the user history tracker database may include metadata associated with the unique user identity of the user and it may be accessed in order to perform the search described in method 500. As mentioned above, the user history tracker database 208 may store and/or manage information on, or related to, each user who uses and/or accesses the DMS 118 and a document access history may be maintained for ordinary users of the system, who may use the DMS 118 to store and retrieve corporate documents. Hence, the DMS 118 can track the editors and contributors of the documents stored thereon and can quickly reproduce these docs given a search by one of these users. For example, user history tracker data may be used in subsequent search requests to customize search results for the user. Such process may be iterative, such that the system 100 continuously learns any given user's search patterns and required data to provide ever more germane results.

At step 506, a user search modifier that modifies a search of the user based on one or more user search modifier factors may be generated. The search modifier factors may include information such as, for example, a user's department within an organization, a user's previous search history, a user's time spent reading a particular type of document, a user's total number of pages read in a particular type of document, a number of documents a user has produced and/or edited by document type (e.g., a number of audit reports a user has generated or edited, a number annual product quality reviews a user has generated or edited, etc.) The user modifier factors may be stored, for example, in the user history tracker database and/or the department database. In some examples, it may be necessary to screen one or more documents from users within a department and/or within an organization (e.g., in the case of two subsidiary legal departments, which legal departments may require screening of documents between the two) and the user modifier factors could be used to screen search results such that documents tagged with a relevant tag are not visible to one or more users to which they should not be provided.

Once the search request has been modified based on the user search modifier, at step 508, the modified search request including at least one key term may be presented. The modified search request can include any number of key terms connected by a search logic (e.g., a Boolean logic). The search request is presented to the search documents function of an external server, for example, the raw documents storage 214 via the DMS 118.

At step 510, a search response based on the presented search request may be received. In some embodiments, the search response may be ranked or scored based on the modified search and the rank may be designed to correlate to the relevance of the particular search result to the individual user profile. For example, the number of documents that a user has opened and/or read that are similar to a returned document may affect the overall ranking of any particular document within the search results. Similarly, if a user has drafted and/or edited a particular type of document or document that includes a particular type of metadata, that type of document and/or document with that metadata is likely to be more highly ranked in search results provided to the user. In some embodiments, a likelihood that the user will open a particular type of document may be determined and the likelihood that the user will open the particular type of document may be used to change the priority of the document to the user within the user's search results. For example, if a document is more likely to be opened by a user, the document may be provided higher within the search results. The likelihood that the document is to be opened can be determined based on, for example, the number of times in the past a user has opened a particular type of document, the number of documents a user has produced and/or edited with a document type that are similar to the search-result document, and other factors.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray Disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

1. A method of generating refined search results comprising:
receiving, from a user, a unique identity associated with the user;
generating a unique user search profile based on the unique identity associated with the user;
receiving, from the user, a first search query including at least one key term;
applying the unique user search profile to the first search query to query one or more databases from a selected plurality of databases to generate a unique user first search query;
generating a unique first search result comprising a plurality of first search result documents based on the unique user first search query;
generating ranking rules based on the unique user search profile, wherein the ranking rules include a plurality of weights associated with the unique user search profile; and
providing the unique first search result comprising the plurality of first search result documents to the user, wherein the plurality of first search result documents are ranked based on the ranking rules.

2. The method of claim 1, wherein the unique identity associated with the user is based at least upon a department of the user.

3. The method of claim 1, wherein the selected plurality of databases is selected based on the unique user search profile.

4. The method of claim 3, wherein the selected plurality of databases is selected based on a department of the user.

5. The method of claim 1, wherein the unique user search profile is based on a department of the user.

6. The method of claim 5, further comprising:
determining a likelihood the user is to open a particular type of document based on the department of the user; and
including the particular type of document in the unique first search result to the user based on the likelihood the user is to open the particular type of document based on the department of the user.

7. The method of claim 6, wherein the likelihood the user is to open the particular type of document based on the department of the user is based on a total number of times that users from the department have opened the particular type of document.

8. The method of claim 6, wherein the likelihood the user is to open the particular type of document based on the department of the user is based on a total number of times that users from the department have edited the particular type of document.

9. The method of claim 1, wherein the unique user search profile is based on a user document history.

10. The method of claim 1, wherein the unique user search profile is configured such that searches related to a quality event are more likely to be displayed to members having the unique user search profile.

11. The method of claim 1, wherein the unique user search profile is based on preconfigured tags.

12. A method includes:
determining a unique user identity of the user;
accessing at least one database including metadata associated with the unique user identity;
generating a user search modifier that modifies a search of the user based on one or more user search modifier factors;
presenting the modified search request including at least one key term to at least one database including a plurality of documents;
receiving a search response based on the presented search request; and
screening the search response such that the plurality of documents associated with a relevant tag are invisible to one or more users based on the one or more user search modifier factors, wherein the one or more user search modifier factors include one or more of:
a department of the user, a user history of the user; a user history of all users in the user's department.

13. The method of claim 12, wherein the unique user identity associated with the user is based at least upon the department of the user.

14. The method of claim 12, wherein the user search modifier causes search results to be ranked based on one or more metadata tags tagged to data in the plurality of documents.

15. The method of claim 12, wherein the modified search is presented to a plurality of databases.

16. The method of claim 15, wherein the plurality of databases are based in a cloud-based infrastructure.

17. The method of claim 12, wherein the user search modifier is based on a user document history.

18. A method of conducting a search of a database comprising:
identifying a user based on a user profile;
receiving a search query from the user;
modifying the user's search query based on the user profile;
presenting the modified search query to a documents storage;
receiving a search response from the documents storage;
applying a plurality of weights associated with the user profile to the search response; and
presenting the search response to the user, wherein the search response includes one or more ranked search results based on the plurality of weights applied to the search response.

19. The method of claim 18, wherein the modified search query is modified based on a department of the user.

20. The method of claim 18, wherein the modified search query is modified based on a user document history of the user.
